(19) United States
(12) Patent Application Publication
(10) Pub. No.: US 2016/0026016 A1
(43) Pub. Date: Jan. 28, 2016

(54) Patterned layer for a liquid crystal display device that functions as an edge seal, or internal spacer, or internal gasket, or internal wall, and a precise method to manufacture the patterned layer

(71) Applicant: Allen Howard Engel, Auburn, WA (US)

(72) Inventor: Allen Howard Engel, Auburn, WA (US)

(21) Appl. No.: 14/338,270

(22) Filed: Jul. 22, 2014

(51) Int. Cl. G02F 1/1339

(52) U.S. Cl. CPC G02F 1/1339

(57) ABSTRACT

An adhesive patterned layer for a liquid crystal display device that functions as an edge seal, or internal spacer, or internal gasket, or internal wall. The layer has a precise thickness dimension. The layer is comprised of a uv curing resin or a resin that inhibits the ingress of water or gases. The adhesive layer can be a destruct bond. The patterned layer is formed by casting the resin in a mold, and then releasing the resin from the mold, adhering the cast resin to a substrate of the liquid crystal display.

### BACKGROUND

### Prior Art

The following is a tabulation of some prior art that presently appears relevant:

U.S. Patents

| Patent Number | Date | Patentee |
|---|---|---|
| 4,094,058 | 1978 Jun. 13 | Yasutake et al. |
| 4,228,574 | 1980 Oct. 21 | Culley et al. |
| 4,924,243 | 1990 May 8 | Sato, Masahiko |
| 4,933,120 | 1990 Jun. 12 | D'Amato, et al. |
| 4,924,243 | 1990 May 8 | Sato, etal. |
| 5,003,915 | 1991 Apr. 2 | D'Amato, et al. |
| 5,116,548 | 1992 May 26 | Mallik, Donald W. |
| 5,268,782 | 1993 Dec. 7 | Wenz |
| 6,440,277 | 2002 Aug. 27 | D'Amato et al. |
| 6,775,036 | 2004 Aug. 10 | Cox, John E. |
| 7,887,722 | 2011 Feb. 15 | Wu, et al. |
| 8,316,764 | 2012 Nov. 27 | Wu, et al. |

Foreign Patent Documents

| Foreign Doc. Nr. | Cntry Code | Pub. Dt | App or Patentee |
|---|---|---|---|
| 1586900 | CN | 2005 Mar. 2 | Wu, et al. |

### PUBLICATIONS

Prior art edge seal adhesives and sealants are not optimized for use as the edge seal for the flexible polymer substrates of a flexible lcd display.

Rigid liquid crystal displays have seals composed of metal, or glass frit, or rigid thermoset polymer, or thermoplastic polymers. During curing and after curing of these seals, the rigid seals cannot be handled around roll to roll production machines without the seals delaminating and allowing the liquid crystal fluids to emit from the display.

Prior art edge seal adhesives are not suitable for roll to roll, high speed production. Roll to roll flexible display manufacturing requires seals with high gel strength, high green strength, and high tack to quickly form a permanent lamination of the liquid crystal display cell substrates and other components.

Prior art displays are coated using batch processes, which are considerably slower than roll to roll coating processes. Many uncured industrial adhesives have low viscosities and little gel strength and do not resist compression.

In prior art displays the liquid crystal chemicals occupy the entire display cell, including the areas which are not electrically addressed.

Prior art also teaches glass or plastic fibers as spacers for liquid crystal displays, and glass or plastic balls also. These spacers have limited functionality, whose limited function is to serve as vertical spacers to maintain the cell gap formed by the substrates.

Because of the relatively high durometer of glass or rigid plastic, these spacers do not compress and do not conform to the inside surfaces of the cell substrates. Only a small area of a glass or plastic fiber or ball is in direct contact with the substrates.

Sometimes balls or fibers should be handled as hazardous materials because they are quite possibly respirable. Respirable fibers are those that can penetrate into the alveolar region of the lung upon inhalation; in humans, a fiber with an aerodynamic diameter of less than 5 μm is respirable (EPA 2001). Aerodynamic diameter, unlike geometric diameter, takes into account fiber density and aspect ratio (ratio of length to diameter). The World Health Organization defines respirable fibers as less than 3 μm in diameter and over 5 μm long, with an aspect ratio of at least 3:1 (WHO 2000). These dimensions are comparable to some of the balls and fibers used in industry.

Balls and fibers are distributed onto the substrates of the display cell. If done improperly, the balls and fibers can contaminate the work area. Also, if the balls and fibers are not distributed evenly onto the substrate they can cause the display to have an uneven appearance.

Few balls or fibers are self adhesive.

Balls and fibers are costly.

Prior art teaches spin coating resins onto liquid crystal display substrates. Spin coating wastes more than 90% of the expensive resin. In addition, the spin coat resins need substantial further processing to make functional structures inside the liquid crystal display cell.

Catalyst activated thermoset resins polymerize more slowly than ultraviolet cured resins, slowing production.

Thermoplastic hot melt resins require considerable dwell time to become tacky, also slowing production.

4,094,058 Yasutake et al. 1978-6-13 describes manufacturing a liquid crystal display. The device described in this patent would not function without at least a polarizer or other similar optical component. Polarizers are required for all electrically driven liquid crystal displays: dynamic scattering mode, twisted nematic, super twisted nematic—all require polarizers. Polymer dispersed liquid crystal displays and cholesteric liquid crystal displays became patent years after 4,094,058. The display device described in 4,094,058 does not describe any device which functions as a display.

U.S. Pat. No. 4,924,243 Sato, et al. 1990-5-8 describes a method for forming spacers by printing.

The patent describes a resin which shrinks from 20 microns to 2+−0.5 microns. There are few resins known, certainly no epoxy adhesives, that do not contain solvent or air which can shrink 90%. Claim 5 states that the resin is an epoxy adhesive.

The patent does not state how the (tacky) adhesive releases from the scratched cylinder. The patent does not consider that it is not common for a gravure cylinder to release 100% of each gravure cell's contents, especially when the objective is to lay down a coating 20 microns thick.

The patent does not consider that there is no known squeegee and gravure cylinder assembly wherein 100% of the adhesive remaining on the outer surface of the cylinder (the unengraved “land” area) is removed. Usually a minute amount of residual ink is transferred to the surface being printed. The remaining ink coating is so thin that it is transparent to the human eye. However, even a minute thickness coating can have dramatic results for the performance of a liquid crystal display. In particular ferroelectric displays are known to be readily distorted by minute surface disturbances.

The patent claims a “printing roll engaged with said cylinder which receives said material . . . and transfers . . . to a surface of said substrate” Doing so is very problematic. The surface characteristics of the printing roll engaged are not the same as the surface characteristics of the substrate. To claim that an uncured epoxy adhesive 20 microns thick will transfer completely from the hard scratched cells of the cylinder to the surface of the printing roll engaged, and then transfer completely from the printing roll to the substrate is problematic.

In addition, the display requires baking at 150 C for an hour, which exceeds the usage temperatures of commodity polymer substrates.

U.S. Pat. No. 4,228,574 Culley et al. 1980-10-21 describe a roll to roll continuous process of manufacturing (twisted nematic) liquid crystal displays. A full critique of 4,228,574 is outside the purpose of this document, so I will highlight a few of the embodiments described in 4,228,574.
(1) In 4,228,574 A polarizer is attached to a birefringent mylar film. This is improbable, because the birefringent films listed in the patent would distort the function of the polarizer.
(2) In 4,228,574 The transparent conductor indium tin oxide would likely develop shorts as it is handled by the numerous stations downstream from the indium tin oxide application station.
(3) In 4,228,574 applying a photoresist film and patterning a photoresist film usually requires an intermittently moving production line, to allow for exposure of the photoresist, and the removal of the resist in multiple liquid chemical baths. But many of the other stations described in the patent require a continuously moving production line.
(4) In 4,228,574 Rubbing direction is critical to the functioning of liquid crystal displays. To optimize the rubbing, the polarizer orientation and the rubbing direction cannot both be parallel to the moving machine direction of the web, nor both parallel to the traverse machine direction. The patent does not adequately describe the means to rub the carrier substrate continuously.
(5) In 4,228,574 Liquid crystal material with fiber spacers is introduced between the top and bottom films. The patent does not indicate the means whereby the liquid crystal material and fiber spacers are introduced, and the means of doing so on a continuous production line is not trivial.
(6) In 4,228,574 Conductive epoxy is introduced between the top film and the bottom film. Epoxy, polymerized by heat and catalyst, is another example of a process station that is intermittent, and curing of the catalyst requires significant dwell time.

If U.S. Pat. No. 4,228,574 were efficient, the assignee would likely have commercialized the processes during the past 35 years.

U.S. Pat. No. 4,924,243 1990-5-8 Sato et al. describes a thermoset epoxy resin which requires significant dwell time to polymerize.

U.S. Pat. No. 5,268,782, Wenz, 1993-12-7, the ribs are not self-adhesive. An adhesive layer is applied to the top of the ribs in another step. Applying the minute thickness adhesive layer to the top of the ribs is not a trivial process. Achieving a robust bond with the minute thickness adhesive layer is not trivial either.

### Advantages

Accordingly several advantages of one or more aspects are as follows: the patterned layer would be multifunctional, the layer would not delaminate from the display substrate during processing because of its high gel strength, green strength, and high tack; the layer would be a destruct bond which would resist the liquid crystals from leaking from the cell, the layer would occupy the areas of the cell which are not electrically addressed, the manufacturing coating thickness tolerance for the layer is precise within scores of nanometers or less; the layer microstructures have large surface areas in contact with the cell substrates, the microstructures have limited or no toxicity, the manufacturing is quick because the resins polymerize with industrial radiation sources; the manufacturing is efficient involving only a couple of steps, and hence is low cost; and the manufacturing can simultaneously cast many different functional structures with using same roll to roll casting machinery

Other advantages of one or more aspects will be apparent from a consideration of the drawings and ensuing description.

### DRAWINGS—FIGURES

FIG. 1 shows an edge seal 110 printed onto the periphery of the display substrate. Within the edge seal 110 is printed a barrier pattern 112, a gasket 114 occupying the areas of the display which is not addressed, and the liquid crystal material 116, patterned as a 7 segment display character.

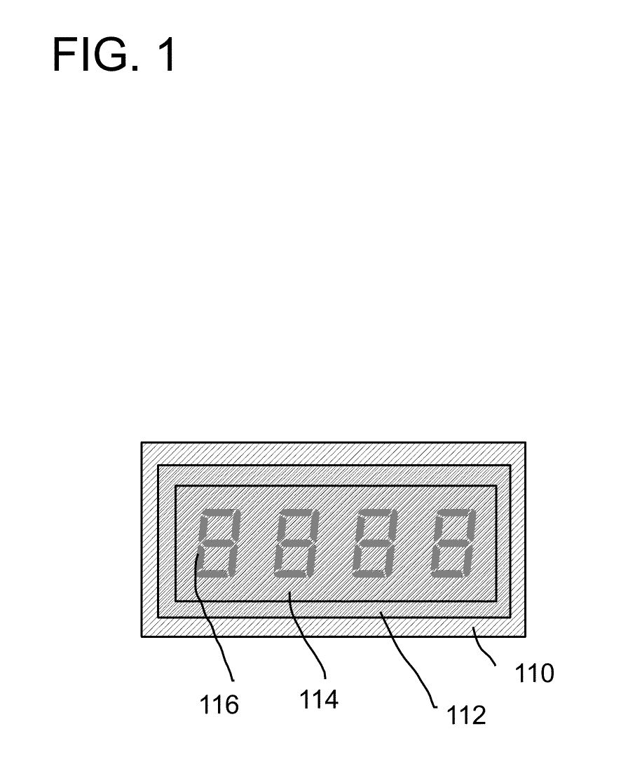

FIG. 2 shows the pattern application of the uncured resin onto the flexible display substrate, the application of the transfer surface to the resin, and the radiation curing of the resin to form microstructures onto the substrate.

### DETAILED DESCRIPTION

Hundreds of millions of 13 segment character lcds and 16 segment character lcds have been manufactured in the past. Only a small portion of the liquid crystal fluid inside these displays is actually addressed. The remainder of the liquid crystal fluid contained inside the cell is never addressed and is a waste of money.

The many embodiments described here perform many functions that are ideal for lcd with flexible polymer substrates.

The adhesive has a good gel strength, high tack, and high green strength. Its high tack and high green strength makes it possible to handle the plcd web at typical printing press speeds, before the pdlc has been cured, without the laminate delaminating as it is handled around rollers downstream from the lamination nip. It is not necessary to partly cure or partly gel the adhesive before applying the liquid crystal mixture to the substrate. The adhesive's high green strength means that the laminate will not delaminate even though the uv curing adhesive has not yet been exposed to uv light.

The adhesive can be applied to the substrate with industrial printing equipment like flexographic printing equipment, gravure printing equipment, offset printing equipment, screenprinting equipment, inkjet equipment, intaglio equipment, and other forms of printing equipment.

The adhesive contains free radical curing polymers, free radicals that cure with ultraviolet light. Therefore the seal can cure simultaneously with the pdlc mixture. Other forms of radiation curing such as electron beam, laser curing, visible light curing, cationic curing and others are also suitable.

The adhesive has a relatively high gel strength uncured, and a sufficient resistance to compressibility after curing to function as an edge seal around the periphery of the display, or as an internal gasket, or as an internal wall, or as an internal spacer within the display laminate. The adhesive's high gel strength and its resistance to compression resists environmental forces that affect the display. The adhesive helps to maintain the order of the liquid crystal coating deposited within the laminate.

The layer also functions as a spacer. Prior art spacers like glass balls and polymer balls are very expensive. The layer functions as an economical spacer, and so glass balls or polymer balls are not necessary.

As an internal spacer, the seal also prevents the delamination of the display during use. The seal adhesive is so strong that it is considered a destruct seal. A destruct seal is defined during tearing tests like ASTM D903-98, wherein one of the laminated substrates tears before the lamination bond fails. The adhesive is optimized to form a gasket with a destruct bond aka destruct seal.

Recent advances in nanotechnology fabricate devices with thickness tolerances in the scores of nanometers. These nanotechnology processes are called uTM molding, nanoreplication, soft holography, soft lithography, and the like. High speed commercial systems are available from James River Products and Breit Technologies.

The adhesive inhibits the migration of oxygen and moisture into the display laminate. Sartomer teaches in Publication 5068 Influences on Barrier Performance of UV/EB Cured Polymers and offers formulations with high barriers against moisture vapor and oxygen gas. The display can have an edge seal with a destruct bond edge seal around the periphery of the display, and an internal seal patterned inside the edge seal. The internal seal patterned inside the edge seal can function as a barrier to the ingress of water and oxygen into the display.

The process for production of a display panel having a pair of spaced apart flexible substrates and display medium sandwiched therebetween is also provided. A first sealant which strongly adheres to the substrates is printed on the interior surface of one substrate. A second seal, which has low water permeability, is printed on the other substrate. A spacer is scattered on at least one of the substrates. The substrates are then combined together and the sealants are cured to form a display panel.

The display panels constructed in accordance with this invention are composed of a display medium layer, a pair of flexible substrates sandwiching the display medium layer and a multiple structure seal. At least one part of the multiple seal is constructed of a resin having strong adhesion to the flexible substrates and another part is made of a resin having low water permeability. This separation of functions is usually necessary because resins having strong adhesion to the flexible substrates are generally high in water permeability. Where the resin which strongly adheres to the flexible substrate has high water permeability it is desirable that it have low gas permeability.

The term seal as used herein means for the resins having low water permeability an assembly constructed so that at least one layer of the low water permeability resin completely surrounds the liquid crystal or other display medium layer except at the liquid crystal, or other display medium, inlet. However, the resin having strong adhesion to the substrate need not be continuously formed around the liquid crystal layer. In other words, a part of the “seal” formed by the strongly adhesive resin may be partially discontinuous.

One way of forming the seal is to have the sealing member on the liquid crystal layer side made of the low water permeability resin and the outer side sealing member being made of the strongly adhesive resin. However, it is also possible to reverse the relative placement of the seal parts.

Flexibility is herein defined as the property of a substance which prevents it from being easily broken when bent and remaining undamaged even when the substrate has a curvature imparted to it.

It is generally preferable if the sealing member on the liquid crystal layer side of the seal is made of a material which does not easily react with the liquid crystal.

Hereinafter, the advantage of the dummy seal of sealant particles will be described in greater detail. In an STN liquid crystal display panel or a ferroelectric liquid crystal display panel, display unevenness can be caused by even a very small cell gap variation due to an undulation of the substrate. Moreover, as the performance of a liquid crystal display panel has been improved in recent years, the demand for reducing or eliminating the display unevenness has been increasing. When an internal spacer is sandwiched between a pair of substrates, the substrates are supported at a plurality of points and planar surfaces. Therefore, the stress acting upon each substrate is diffused, thereby diffusing the stress acting upon each substrate and thus suppressing the undulation of the substrate.

### Example 1

A seal pattern formed on a substrate of a liquid crystal device (LCD) is provided. The seal pattern at least includes a primary seal pattern that substantially surrounds the active area of the LCD and optionallay a second destruct bond seal pattern that is formed at least partially inside the primary seal pattern. The dummy seal pattern can be formed substantially around one or more active areas of the LCD. The dummy seal pattern includes a plurality of discontinuous seal portions. Methods for making an LCD with the seal pattern according to this invention are also provided.

The dummy seal pattern includes a plurality of discontinuous seal portions. These seal portions can be disposed on the substrate in the form of one or more lines, or randomly in any desirable pattern. The seal portions can also have the same or varying sizes, shapes, and orientations.

### Destruct Bond Formulation Example 1:

| | |
|---|---|
| Sartomer CN704 | 0.3 |
| Sartomer CN966 | 0.1 |
| Bomar BR7432 | 3.5 |
| Irgacure Photoinitiator 819 | 0.15 |
| Agitan Defoamer 350 | 0.2 |

### Destruct Bond Formulation Example 2

| | |
|---|---|
| Bomar 7432 | 24.5 |
| Sartomer CN131 | 18.2 |
| Sartomer CN704 | 2.0 |
| Sartomer CN966 | 1.2 |
| Irgacure Photoinitiator 819 | 0.7 |
| Agitan Defoamer 350 | 0.2 |

### Destruct Bond Formulation Example 3

| | |
|---|---|
| Bomar 7432G | 1.5 |
| Sartomer CN704 | 1.5 |
| Bomar 2084 | 20 |
| Irgacure Photoinitiator 819 | 1.0 g |

### Destruct Bond Formulation Example 4

| | |
|---|---|
| Sartomer CN704 | 0.6 |
| Sartomer CN966 | 0.2 |
| Bomar 7432 | 3.5 |
| Irgacure Photoinitiator 819 | 0.15 |

### Example Cationic Cure Water Barrier Formulation Example 5

| | | |
|---|---|---|
| Sartomer Poly bd 605E Resin | 100 | g |
| Dow Cyracure UVRV6110 | 90 | g |
| Dow Cyracure UVR6126 | 10 | g |
| Viking Vikolox 14 | 6 | g |
| Dow Cyracure 6974 | 2 | g |
| OSI Silquest A 189 | 1.5 | g |
| Byk 341 | 0.1 | g |

These exemplary resins form patterned layers to function as liquid crystal display components like spacers, interior walls, interior channels, gaskets, and edge seals formed by micro precision casting of radiation curing resins or radiation curing adhesives or radiation curing hermetic barrier resins or radiation curing gas barrier resins.

To mass produce these liquid crystal display microstructures, liquid resin (oligomer) is held against the web carrier by a master mold with a transfer surface containing a relief of the micro structures, which acts as a mold while the resin is hardened by radiation curing. This process transfers the micro structures from the transfer surface to an exposed surface of the resin.

These resins are typically cured photo-chemically by exposure to ultra-violet radiation, and can, alternatively, be cured by electron beam radiation or laser radiation or near visible radiation or visible light radiation. In the case of an electron beam cure a vacuum chamber with an electron gun is used. Furthermore, it can be beneficial to use a vacuum for the coated substrate during the cure to eliminate oxygen from the curing resin and for other beneficial reasons.

One embodiment provides for a ultraviolet casting station and a substrate supply and take-up mechanism. When the substrate is in the form of a continuous web of sheet material, for example, the supply is in the form of an unwind roll of the web and the take-up mechanism is a take-up roll.

Several embodiments have process steps comprising continually patterning the casting resin on the substrate, molding the resin with a master mold, followed by curing the resin while in the mold, and releasing the cured resin and substrate from the mold.

These techniques can also be used to form cast resin micro-groove stripes that extend completely along the substrate in the direction of movement of the substrate with areas of the substrate existing along the sides of the stripes.

These techniques can be used to form cast resin microstructures that are totally surrounded, or substantially surrounded, by the substrate, such as areas in the shape of a circle, rectangle or some irregular shape.

These micro cast structures can function as edge seals, spacers, gaskets, dummy spacers, channels, walls and other structures. The micro cast structures are cast with sufficient precision to be suitable as components for liquid crystal displays.

The micro structures can be comprised of resins with water barrier properties or gas barrier properties, or high green strength, and can optionally also function as destruct bond adhesives. A destruct bond is a bond wherein the adherends deform or tear before the bond fails.

Discrete micro structures can be most any shape, and can be totally surrounded by other areas of the web. The web is later separated, in one of many embodiments, into substrate sheets, each of which contains one or more of the micro structures. Amongst many alternative methods to use of the continuous web, the individual substrate sheets may be individually fed through the process of forming discrete micro structures on the sheets.

Many of the various embodiments allow micro structures to be made in a continuous process with the application of several layers and in a manner that is analogous to the operation of a printing press. The process is accomplished in a continuous and synchronous matter. Timing requirements can be integrated in the single apparatus.

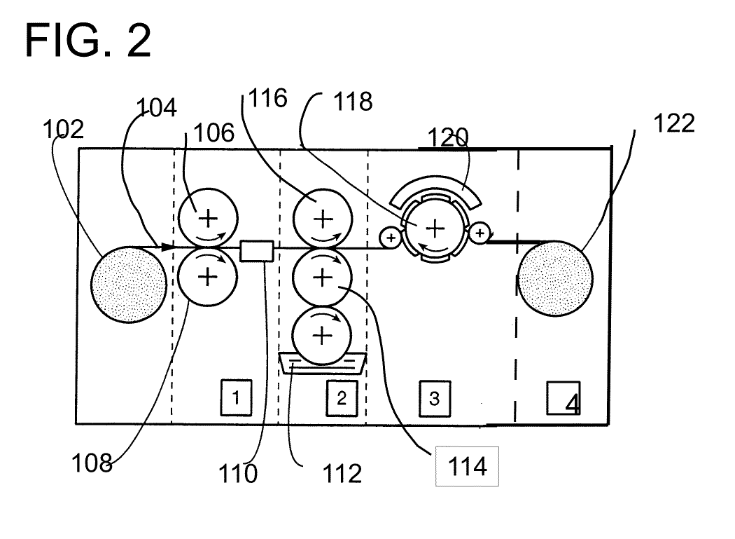

As shown in FIG. 2, one embodiment includes several process steps, and the apparatus for accomplishing these several steps can be described as having several respective sections. The substrate material which is passed continuously through the various process steps is located, as the process begins, on the unwind unit. This substrate material may be a flexible material such as plastic film, in a continuous strand or web, which is later cut into individual substrate sheets. In some embodiments, individual sheets may be passed through the processing stations. When the final step of the process has been completed, the processed substrate material with completed microstructures, is collected in the rewind unit 122.

In another embodiment, a flexible base coat may be applied to the substrate by the base coating unit 108 and then cured by the curing unit 110 as shown in FIG. 2.

A micro structure surface of no particular size is provided. There should preferably good adhesion between this structure and the film. Depending upon the type (or surface energy) of the substrate it may be necessary, to place a sub-coating into the substrate, in the areas that are to receive the casting resin. Such coatings, for example, may be used, or required, to provide flexibility to the substrate, to improve the “hold-out” properties of the oligomer and to prevent it from “soaking” into the substrate. This sub-coating may also be required in order to serve as an intermediate bond between the oligomer and the substrate (a so-called “Tie Coating”) With in-line printing equipment, such a coating can be applied by conventional printing methods. Any conventional device can be used to apply the oligomer to the entire surface of a film, or to discrete areas of the web, or to provide a course image coating or an image in the form of a relatively coarse printing screen such as a 100 line screen to as high as a 600 line screen. The latter screen can also be used (and probably with a pre-coat or sub-coat) as a means of having the micro structure applied to discrete dots. A Gravure unit, a Letterpress unit, a Flexographic unit, or a Silk Screen unit are all possible units for the application of the oligomer. The gravure coating unit and the micro structure cylinder have similar image areas in that each contains the same area of imagery in different form.

A cylinder is shown as one means of applying the micro structure to the substrate. It is also possible to form the required micro image into (on) a thin nickel belt or thin polycarbonate belt. In this case the cylinder is replaced by a belt and a means to drive the belt.

The next process step comprises passing the material-in-process through an image coating unit using oligomer coating. An oligomer may be defined as a liquid or viscous solution for use as a coating, and which is later subject to radiation curing.

U.S. Pat. No. 8,316,764, Wu, 2012-11-27 teaches that “Commercially available energy curable resin coatings also may be obtained from INX International, 150 North Martingale, Schaumburg, Ill. 60173, under the trademarks and product designations PROCURE™ 2009, PROCURE™ 5000, PROCURE™ UV 8005, PROCURE™ UV 1037, PROCURE™ UV 3000, PROCURE™ 5075, PROCURE™ UV 5701, INXFLEX™ Series 2000, INXFLEX™ Series 1000, INXFLEX™ ITX-Free, INXCURE™, UVEXCEL™, INXCURE™ Fusion Hybrid, INXScreen™ UV HP, and INXCURE™ UV Letter Press 12165.”

The next process step is curing the micro structure by use of electron beam radiation or ultraviolet radiation or other radiation in the radiation unit 120.

The oligomer may also be applied directly to the image drum via a gravure or flexogiaphic cylinder, and the image is then cured while in contact with the web.

In some embodiments a flexographic or Gravure roller 114 receives liquid resin from another roller beneath it that is rotated through a bath of resin 112. Liquid resin is then applied by the roller 114 to raised areas of an image drum 118 that contain the surface relief patterns desired to be transferred as microstructures on the devices being formed. Liquid resin held against these surface relief patterns is then cured by the source 120 of radiation.

To summarize the apparatus that performs all of the processing steps between the two spools of the continuous web substrate material, as illustrated in FIG. 2,

(a) an unwind unit 102 having a spool of a flexible substrate material 122;
(b) a first means including a base coating unit 108 for applying a flexible base coat to said material and a curing unit 110 for curing said coat;
(c) a second means including an image coating unit 114 for creating a micro-image by first placing an oligomer on said base coat;
(d) a third means including a radiation source 120 for radiating with electron beams said oligomer-coating on an image drum 118 to cure said micro-image; and
(h) a rewind unit 122 that receives the processed substrate in a rewind spool upon completion of the above process steps.

A wide variety of Self-assembled monolayers can be adhered to the transfer surface of the mold. These molecules self assemble and adhere to many noble metals, including nickel, and form a layer one molecule thick. This layer does not significantly distort the transfer surface of the master mold. Some monolayers, such as alkanethiols, form a very low surface energy release layer onto the transfer surface of the mold, providing a release layer which the resin has little adhesion strength.

Nip rolls or pinch rolls are powered rolls that are used to press two or more sheets together to form a laminated product. The high pressure created at the nip point brings the sheets into intimate contact, and can squeeze out any bubbles or blisters that might cause a defective bond. Nip rolls can be used to laminate sheets using wet adhesives, film adhesive (such as PSA film) or parts covered with hot melt glues or contact cement. Nip roller units can also be used as pullers for material being pulled off of rolls or being fed between operations. Nip rolls are sometimes called laminating rolls, laminators, squeeze rolls, pinch rolls or even wringers.

In some embodiments the resin mixture can comprise thermoplastic resin nanoparticles dispersed in a compatible low molecular weight ultraviolet curing acrylate or ultraviolet curing polyurethane. The low viscosity uv curing acrylate acts as a solute to enable pattern printing of the resin mixture onto the substrate. The ultraviolet curing resin polymerizes sufficiently for the resin microstructure to release from the transfer surface of the mold. However, the loose network of ultraviolet cured polymer does not inhibit the thermoplastic resin from becoming tacky at elevated temperature. Once the mixture becomes tacky, its green strength binds the microstructure to the adherend substrate. Once the display returns back to room temperature, the adhesive bond continues.

In some embodiments the microstructure is adhered to the substrate with ultrasonic welding, ultrasonic radiation. Ultrasonic welding of thermoplastics causes local melting of the plastic due to absorption of vibration energy. The vibrations are introduced across the joint to be welded. In metals, Ultrasonic welding occurs due to high-pressure dispersion of surface oxides and local motion of the materials. Although there is heating, it is not enough to melt the base materials. Vibrations are introduced along the joint being welded. Ultrasonic welding can be used for both hard and soft plastics, such as plastics, and metals.

In some embodiments the microstructure is adhered to the substrate with radio frequency welding, also known as dielectric sealing or r.f. Heat sealing. Certain plastics with chemical dipoles, such as PVC, polyamides (PA) and acetates can be heated with high frequency electromagnetic waves. High frequency welding uses this property to soften the plastics for joining. The heating can be localized, and the process can be continuous.

In radio frequency welding two pieces of material are placed on a table press that applies pressure to both surface areas. Dies are used to direct the welding process. When the press comes together, high frequency waves (usually 27.120 MHz) are passed through the small area between the die and the table where the weld takes place. This high frequency (radio frequency) field causes the molecules in certain materials to move and get hot, and the combination of this heat under pressure causes the weld to take the shape of the die. RF welding is fast. This type of welding is used to connect polymer films used in a variety of industries where a strong consistent leak-proof seal is required.

The most common materials used in RF welding are PVC and polyurethane. It is also possible to weld other polymers such as Nylon, PET, PEVA, EVA and some ABS plastics.

What is claimed is:

1. A patterned layer of resins forming components for a liquid crystal display, and a method for providing said patterned layer onto the substrate of said liquid crystal display.

2. The components of claim 1 are selected from the group comprising edge seals, internal spacers, internal gaskets, or internal walls.

3. The layer of claim 1, comprising an additive with a means for resisting compressive force, thereby maintaining the order of the liquid crystals deposed within the display cell.

4. The layer of claiml, comprising a mixture of resins which has a predetermined gel strength whereby said layer resists being distorted as the display cell is handled around rollers.

5. The layer of claim 1, comprising an additive tackifier with a means for quickly adhering said layer to the substrates of the liquid crystal display or coatings deposed thereinbetween said substrates.

6. The layer of claim 1, comprising a mixture of resins which has a bonding strength which surpasses ASTM D903-98

7. The layer of claim 1, comprising an additive means admixed with said layer for decreasing the ingress of water into said resin.

8. The layer of claim 1, comprising an additive means admixed with said layer for decreasing the ingress of gases into said resin.

9. The liquid crystal display device of claim 1, with a layer which resides within the inactive areas of the liquid crystal display device.

10. A method of manufacturing liquid crystal displays with micro structures suitable as internal components for liquid crystal displays, comprising:
(a) unwinding two flexible continuous substrates,
(b) applying electrodes to the inside surfaces of the two flexible substrates,
(b) applying casting resin mixture to discrete areas of the substrates,
(c) thereafter, holding a micro-structure pattern of a transfer surface against a surface of the resin in the discrete areas of the substrates,
(d) curing the resin while the transfer surface is being held against the resin,
(e) thereafter, separating the transfer surface from the cured resin, thereby to retain the micro-structure pattern in the surface of the casting resin, which is substantially limited to the discrete areas of the substrates,
(f) depositing a liquid crystal mixture onto the inside surface of one of the substrates,
(g) bringing the two substrates together into a lamination nip,
(h) laminating the top substrate to the bottom substrate, thereby encapsulating the liquid crystal mixture thereinbetween, to form a plurality of liquid crystal display cells,
(i) winding the completed lamination around a rewind roller, and
(j) cutting the continuous substrate individual liquid crystal display cells.

11. The display cell of claim 10, wherein the liquid crystal material is selected from the grouup comprising polymer dispersed liquid crystal mixtures, ferroelectric liquid crystals, mixtures forming twisted nematic liquid crystals, mixtures forming super twisted nematic liquid crystals, cholesteric liquid crystal mixtures, and guest host liquid crystals,

12. The liquid crystal mixture of claim 10, wherein said liquid crystal mixture comprises resins with a means for adhering one cell substrate to the other cell substrate.

13. The layer of claim 1, a layer comprising resin mxitures selected from the group comprising resins with a means to become adhesive upon exposure to coherent radiation, or resins with a means to become adhesive upon exposure to ultrasonic radiation, or resins with a means to become adhesive upon exposure to radio frequency radiation, or resins with a means to become adhesive upon exposure to heat, or resins with a means to become adhesive upon exposoure to ultraviolet energry, or resins with a means to become adhesive upon exposure to visible light energy.

14. The layer of claim 1, a layer comprising resin mixtures with a means for adhering one substrate of the liquid crystal display to the other substrate of the liquid crystal display after said resin mixtures have been exposed to electromagnetic radiation.

15. The transfer surface of claim 10, comprising a monolayer of low surface energy molecules having a means for aiding the method of separating said transfer surface from the cured resin.

16. A system for treating a thin, flexible material in a continuous process, comprising
(a) first and second holders of a roll of a continuous web of said material, the first holder being at a beginning of the process, thereby to supply fresh web material, and the second holder being at an end of the process, thereby to take up and hold the web material after treating,
(b) a processing station including a cylinder having a micro-structure master positioned around its circumference and positioned to hold the master against the web with liquid resin contained there between as the cylinder rotates and the web moves through the station, said processing station also including a source of an electron beam directed against the contained resin, thereby to cure the resin, or a source of ultraviolet light directed against the coated resin, thereby to cure the resin, and wherein the processing stations is positioned so that the web moves from the first roll holder, then through the processing station, and then to the second roll.

17. The system of claim 10, wherein the micro-structured master includes a plurality of separated elements spaced apart around the circumference of the cylinder.
